(19) United States
(12) Patent Application Publication
(10) Pub. No.: US 2006/0215209 A1
(43) Pub. Date: Sep. 28, 2006

(54) Print control device, print control method and storage medium storing print control program

(75) Inventor: Masatoshi Takahashi, Niigata (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/211,758

(22) Filed: Aug. 26, 2005

(30) Foreign Application Priority Data
Mar. 23, 2005 (JP) 2005-084173

(51) Int. Cl. G06K 15/00

(52) U.S. Cl. 358/1.14; 358/538

(57) ABSTRACT

A print control device which controls to print according to print data having one or plural image regions where an image is printed, including a setting unit that sets whether or not printing of the image of the image region is omitted, and a print data generating unit that generates print data having a layout for omitting the printing of the image of the image region, when it is set by the setting unit that the printing of the image of the image region is omitted.

### BACKGROUND OF THE INVENTION

1. Field of the Invention

The present invention relates to a print control device, a print control method and a storage medium storing a print control program, more particularly to a print control device, a print control method and a storage medium storing a print control program which enables to perform printing at a low running cost.

2. Description of the Related Art

There are printing devices having a saving mode which allows to print at a low running cost by decreasing the use of consumable items such as a print toner and print sheets in volume in these years. These printing devices decrease the number of print sheets used by adopting an N-up print which prints plural pages on one print sheet, a reduced print which contracts a print image itself such that print data of plural pages is contracted to be printed on one print sheet, and the like.

In addition, the amount of toner used is decreased by lowering the output resolution at the time of printout or by thinning out the painted-out pixels when images or figures having many painted-out portions are included. Further, there is a method for realizing the printout by reversing colors when the painted-out area is large relative to the sheet size.

There is a problem that a desired print image cannot be printed because print quality is degraded when the printout is performed with output resolution lowered or with the painted-out pixels thinned out.

It is general that a pattern of thinning out pixels is previously designated, and the printout using the designated thinning out rule had a problem that it did not necessarily contribute to the reduction of the consumable articles.

There is disclosed a related art in Japanese Application Patent Laid-Open No. 2004-17389 that by controlling to switch a thinning out pattern according to the feature of image data to be printed according to a print material-saving mode designated by a user and a print material-saving mode judging material, a good output image desired by the user can be obtained as one optimum for the output result desired by the user is automatically selected from the plural pixel thinning out rules (thinning out patterns) depending on an output image pattern in the print material-saving mode.

According to a related art disclosed in Japanese Patent Application Laid-Open No. 10-177528, necessary information is obtained from a WWW server and a support server and synthesized and processed to generate new hyper text information, and partial information contained in the generated hyper text information is deleted before sending to a destination terminal, thereby enabling to reduce a data size.

But, the related art described in Japanese Patent Application Laid-Open No. 2004-17389 is a technology that an output image closer to the user's desire can be obtained mainly by automatically selecting and switching a thinning out pattern according to the property of print data, but it is not sufficient to save print sheets even if it is possible to save the toner because the entire image is thinned out by a pattern.

And, the related art described in Japanese Patent application Laid-Open No. 10-177528 has a problem that information necessary at the time of displaying may not be displayed though it is possible to decrease communication traffic by decreasing a data size by partly deleting the hypertext information.

In addition, the related art described in Japanese Patent Application Laid-Open No. 10-177528 has a problem that the running cost involved in the image formation cannot be reduced because it is intended to decrease the communication traffic.

### SUMMARY OF THE INVENTION

The present invention has been made in view of the above circumstances and provides a print control device, a print control method and a storage medium storing a print control program which can perform printing at a low cost without lacking the image required by a user.

An aspect of the present invention provides a print control device which controls to print according to print data having one or plural image regions where an image is printed, including: a setting unit that sets whether or not printing of the image of the image region is omitted; and a print data generating unit that generates print data having a layout for omitting the printing of the image of the image region, when it is set by the setting unit that the printing of the image of the image region is omitted.

### BRIEF DESCRIPTION OF THE DRAWINGS

FIG. 1 is a structure view of a print control system configured by applying a print control device, a print control method and a print control program according to an embodiment of the present invention;

FIG. 2 is a flow chart showing a flow of processing by the print control device according to the embodiment of the present invention;

FIG. 3 is a flow chart showing a flow in detail of the rectangular image expansion processing shown in FIG. 2;

FIG. 4 is a view showing a screen used to set print conditions; and

FIG. 5A through FIG. 5D are views showing output images obtained by executing the processing shown in FIG. 2 and FIG. 3.

### DETAILED DESCRIPTION OF THE INVENTION

An embodiment of a print control device, a print control method and a print control program according to the present invention will be described in detail with reference to the accompanying drawings.

The embodiment of the present invention will be described with an image region, which is a region of images and figures included in print data required to be printed, determined as a rectangular image, but the invention can be practiced without limiting to the embodiment.

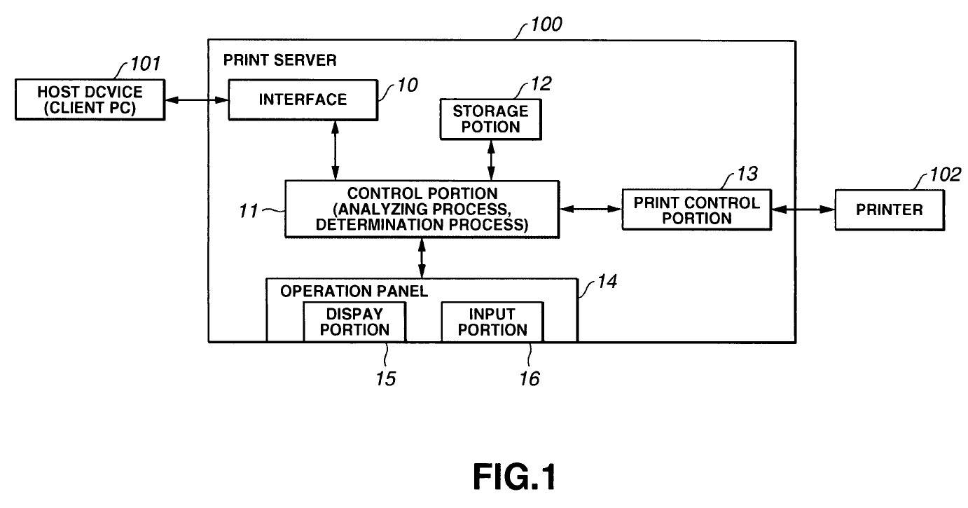

FIG. 1 is a structure view of a print control system configured by applying a print control device, a print control method and a print control program according to an embodiment of the present invention.

The print control system shown in FIG. 1 includes a print server 100, a host device 101 which sends a print request to the print server 100 such as a client PC, and a printer 102 which performs printout.

The print server 100 has an interface 10, a control portion 11, a storage portion 12, a print control portion 13, an operation panel 14, a display portion 15 and an input potion 16.

The interface 10 communicates with the host device 101 or the like which is connected through a communication line to receive a print request for print data having print conditions. The received print request is transferred to the control portion 11. The print data at this time includes one or plural image regions, and a rectangular image is shown as an example of the image region in this embodiment.

The control portion 11 performs main control of the print server 100 and is comprised of a CPU and the like. It receives the print request transferred by the interface 10 and analyzes the print data having the print conditions requested to be printed. It temporarily stores the settings related to the handling of the rectangular image as one of the print conditions and the print data in the storage portion 12.

The contents of settings to form an output image to be printed are determined according to the print conditions and transferred to the print control portion 13.

In rectangular image setting items as one of the print conditions, “Do not print” the rectangular image is designated when printing with the rectangular image omitted, and “Print” the rectangular image is designated when printing without omission. When “Print” is selected, either “Thin out or Do not thin out” the rectangular image is further designated. When “Do not print” is selected, “Maintain layout or Fill layout” is further designated.

The contents of settings are determined from these print conditions.

The storage portion 12 is comprised of a ROM (Read Only Memory) and a RAM (Random Access Memory) and stores a program for controlling printing and various types of parameters. In addition, it temporarily stores the print data requested to be printed and its print conditions and provides a temporary storage area at the time of controlling by the control portion 11.

The print control portion 13 generates an output image to be printed according to the setting contents transferred from the control portion 11 and performs printout by the printer 102.

The operation panel 14 is a user interface operable by a user and comprised of the display portion 15 and the input portion 16.

The display portion 15 shows a screen or the like and is a display interface for displaying the print settings and the like.

The input portion 16 is an input interface such as a mouse, a keyboard and the like and can perform various types of settings and maintenance related to the printout.

By configuring as described above, the printout excluding the rectangular image can be made according to the settings of the rectangular image included in the print conditions even when the print data including the rectangular image is requested to be printed.

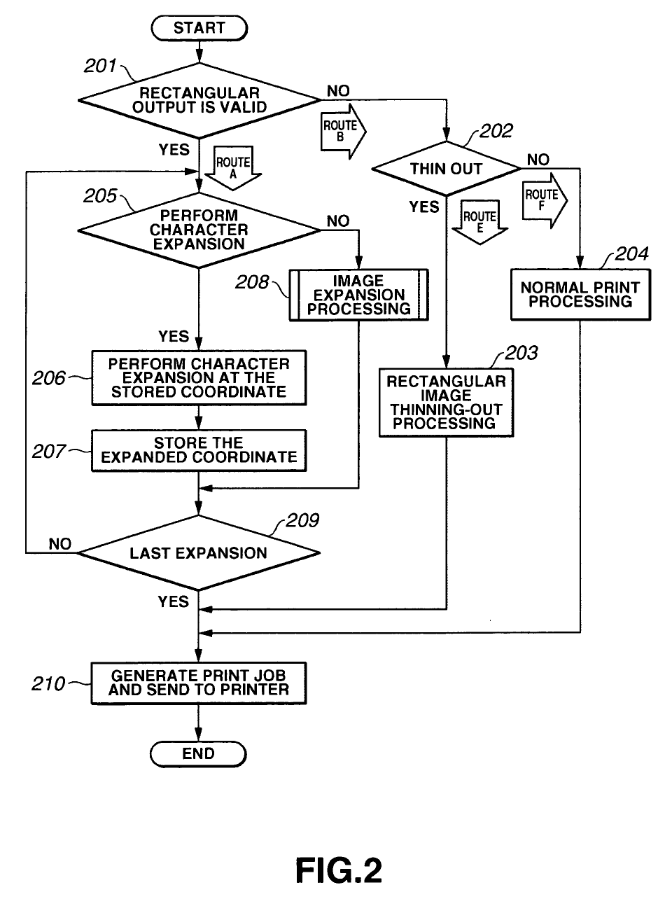

FIG. 2 is a flow chart showing a flow of processing by the print control device according to the embodiment of the present invention.

In FIG. 2, the processing is started when a print request is made by a client, print data having print conditions requested to be printed is temporarily stored in the storage region, and it is judged whether a flag indicating whether or not the rectangular image included in the received print conditions is printed is valid (flag state: ON) (S201). When the flag is valid (flag state: ON), the rectangular image is not printed, and when the flag is invalid (flag state: OFF), the rectangular image is printed. At this time, the former route is determined as “Route A” and the latter route is determined as “Route B”).

When the flag is in an invalid state (flag state: OFF) and the rectangular image is printed (NO in S201), a method of printing the rectangular image is subsequently judged according to the print conditions included in the print request. In other words, it is judged whether the printing is performed with the rectangular image thinned out or normal (S202). When the printing is performed with the rectangular image thinned out (YES in S202), the whole rectangular image included in the print data requested to be printed is subjected to thinning-out processing (S203). Here, for the rectangular image thinning-out processing, there are methods which print out with resolution set lower than the normal resolution, print out with the image partly omitted, and the like.

Meanwhile, when the rectangular image is not thinned out (NO in S202), the normal print processing is performed (S204).

By the above-described steps (S203, S204), a print job of the processed print data is generated and sent to the printer (S210).

And, when it is judged whether or not the rectangular image is printed and the printing is not performed (YES in S201) with the flag in the valid state (flag state: ON), it is judged whether the subject of the print data requested to be printed is a character (character expansion or not) (S205), and if a character (YES in S205), the character is expanded at coordinates where print data sent as a print request is stored (S206), and the expanded coordinates are stored (S207).

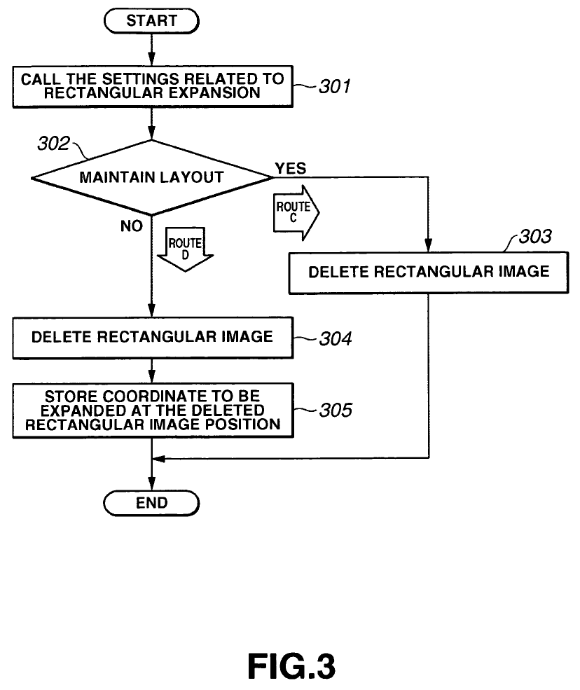

If the subject to be processed is not a character, namely it is a rectangular image (NO in S205), the rectangular image is expanded according to the temporarily stored print conditions (S208). A flow in detail of the expansion processing of the rectangular image is shown in FIG. 3.

When the expansion is carried out by either the character expansion or image expansion processing described above, it is judged whether the entire print data requested to be printed has been expanded (S209). If the entire print data has been expanded (YES in S209), a print job is generated according to the coordinates of the expanded character or rectangular image and sent to a designated printer (S210).

If the entire print data has not been expanded (NO in S209), the step of judging whether it is character expansion (S205) and following steps are repeated.

Thus, a print job having the character expansion or the rectangular image expansion performed or a print job having the rectangular image thinning-out processing performed can be printed by a printer.

FIG. 3 is a flow chart showing a flow in detail of the rectangular image expansion processing shown in FIG. 2.

The flow chart shown in FIG. 3 is a flow chart when a flag indicating whether or not the rectangular image is printed is valid (flag state: ON) and when the rectangular image is not printed out.

In FIG. 3, when the rectangular image is requested to be expanded, a setting related to the image expansion of the rectangular image is invoked from the print conditions temporarily stored at the time of receiving the print request (S301), and it is judged whether the printout is effected in a state keeping a space for the rectangular image produced by not printing out the rectangular image (a state with the layout maintained) (S302). (A route to print out in a state keeping the layout is determined as “Route C” and a route to print out in a state not keeping the layout is determined as “Route D”.)

When the printout is effected while keeping the layout (YES in S302), the rectangular image is deleted (S303).

When the printout is effected in a state that the space of the rectangular image produced by not printing out the rectangular image is filled (a state not keeping the layout) (NO in S302), the rectangular image is deleted first (S304). Then, the coordinate position where the deleted rectangular image was laid out is stored (S305). Thus, it becomes possible to print out the character to be expanded next by moving it into the position of the rectangular image.

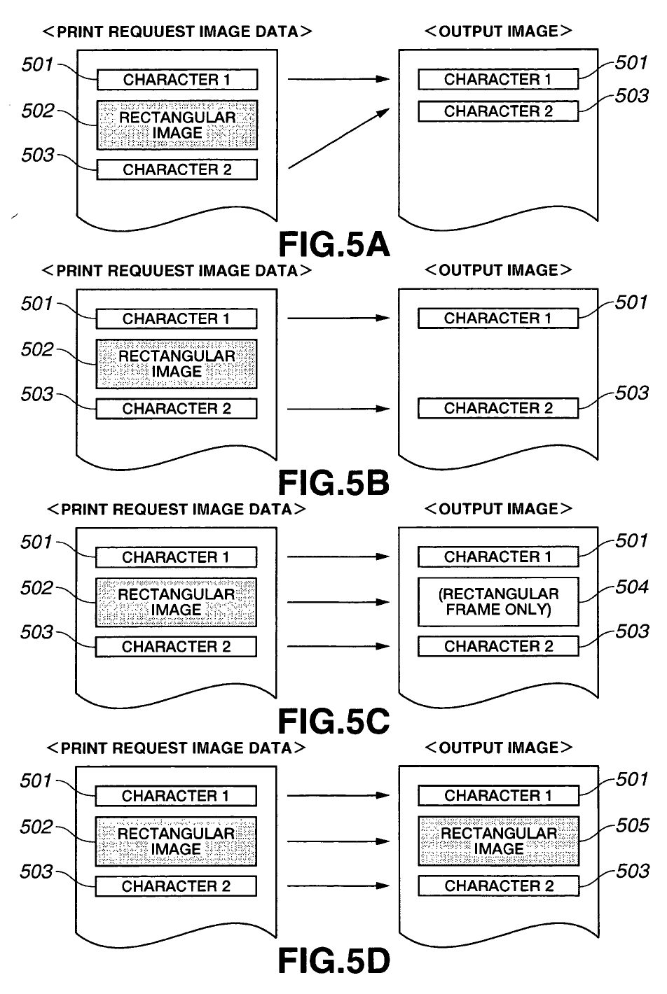

The results obtained by the flow of processing shown in FIG. 2 and FIG. 3 are shown in FIG. 5A through FIG. 5D.

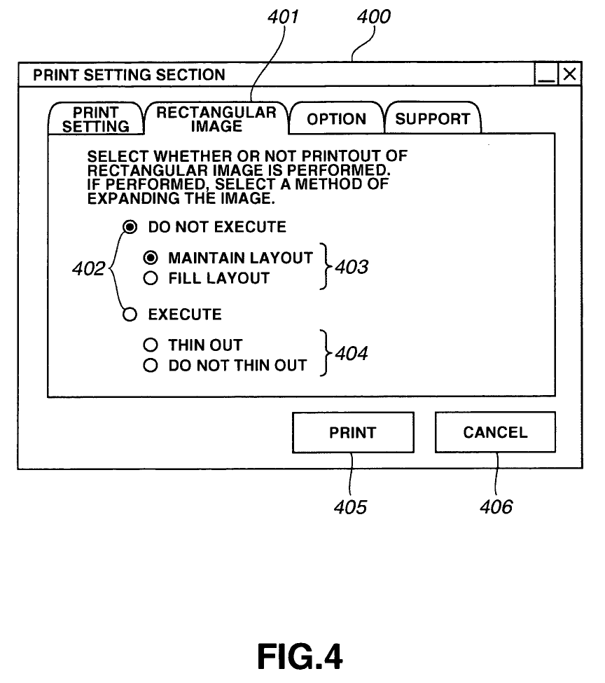

FIG. 4 is a view showing a screen used to set up print conditions.

FIG. 4 is a print setting screen on which a rectangular image processing can be designated to make a print request.

When a rectangular image tab 401 is selected to set the handling of the rectangular image, a printout judgment check box 402 is checked to select whether or not the rectangular image included in the print data requested to be printed is printed out according to the flows shown in FIG. 2 and FIG. 3. When a check button for not executing the printout is selected in the printout judgment check box 402, a method of image expansion of the rectangular image (a method how to process the rectangular image space resulting from no printing of the rectangular image) is selected in an image expansion method check box 403.

When a check button for executing the printout is selected in the printout judgment check box 402, it is selected by a thinning-out selection check box 404 whether the rectangular image thinning-out processing is executed.

And, when the print setting of every tab is made and a print button 405 is pressed, printing is performed by the designated printer. And, the printout setting is cancelled by pressing a cancel button 406.

Flows of processing for printing under the conditions determined by checking in the individual check boxes (402, 403) will be described in correspondence with the routes shown in FIG. 2 and FIG. 3.

When “Do not execute” the printout of the rectangular image is checked in the printout judgment check box 402, a transition is made to “Route A (the route of YES in S201)” judged as valid in the step (S201) to judge whether the printout of the rectangular image is valid or invalid shown in FIG. 2.

When “Execute” the printout of the rectangular image is checked in the printout judgment check box 402, a transition is made to “Route B (the route of NO in S201)” judged as invalid in the step (S201) to judge whether the printout of the rectangular image is valid or invalid shown in FIG. 2.

In addition, when “Maintain layout” is checked in the image expansion method check box 403 with “Do not execute” the printout of the rectangular image checked in the printout judgment check box 402, a transition is made to “Route C (route of YES in S302)” to execute processing in a state keeping the layout according to the judgment whether the step is executed in the state that the space produced by not printing out the rectangular image is maintained (S302) shown in FIG. 3.

Meanwhile, when “Fill layout” is checked in the image expansion method check box 403, a transition is made to “Route D (route of NO in S302)” to process in the state not keeping the layout by the judgment whether processing is executed in a state keeping the space produced by not printing out the rectangular image (S302) shown in FIG. 3.

And, when “Thin out” the rectangular image is checked in the thinning-out selection check box 404 in the state that “Execute” the printout of the rectangular image is checked in the printout judgment check box 402, a transition is made to “Route E (route of YES in S202)” to execute processing with the rectangular image thinned out according to the judgment (S202) whether or not the processing is performed with the rectangular image thinned out as shown in FIG. 2.

On the other hand, when “Do not thin out” the rectangular image is checked in the thinning-out selection check box 404, a transition is made to “Route F (route of NO in S202)” to execute processing with the rectangular image not thinned out according to the judgment (S202) whether or not the processing is performed with the rectangular image thinned out as shown in FIG. 2.

As described above, printout can be made according to the conditions selected by the user.

FIG. 5A through FIG. 5D are views showing the output images obtained by executing the processing shown in FIG. 2 and FIG. 3.

In FIGS. 5A, 5B, 5C and 5D, the views shown on the left side indicate print data requested to be printed by a host device such as the client PC, and the views shown on the right side indicate the output image under the prescribed print conditions.

FIGS. 5A, 5B and 5C are views showing the output results under the print conditions not to print out the rectangular image. FIG. 5D is a view showing the output results under the print conditions to print out the rectangular image.

FIG. 5A is a view showing an output image when “Do not execute” is checked in the printout judgment check box 402 on the print setting screen and “Fill layout” is checked in the image expansion method check box 403 shown in FIG. 4.

It shows an output image obtained by deleting a rectangular image 502 from print-requested print data consisting of character 1 (501), the rectangular image 502 and character 2 (503), and moving the character 2 (503) into the space where the rectangular image was deleted.

FIG. 5B is a view showing an output image when “Do not execute” is checked in the printout judgment check box 402 on the print setting screen and “Maintain layout” is checked in the image expansion method check box 403 shown in FIG. 4.

It shows an output image similar to that of FIG. 5A obtained by deleting the rectangular image 502 of print data requested to be printed and keeping the space resulted from the deletion of the rectangular image as it is.

FIG. 5C is a view showing an output image when “Do not execute” is checked in the printout judgment check box 402 on the print setting screen and “Maintain layout” is checked in the image expansion method check box 403 shown in FIG. 4.

It shows an output image obtained by remaining only a rectangular frame 504 of the rectangular image 502 of the print data requested to be printed and printing out the rectangular frame 504 instead of the rectangular image 502.

And, FIG. 5D is a view showing an output image when “Execute” is checked in the printout judgment check box 402 on the print setting screen and “Thin out” is checked in the thinning-out selection check box 404 shown in FIG. 4.

FIG. 5D is an output image to be printed out having a rectangular image 505 obtained by thinning out the rectangular image 502.

As described above, the output image can be generated under the print conditions determined by the user.

By the processing described above, it is possible in the image forming system of the present invention to print out by deleting a rectangular image that uses a toner amount more than that for characters according to the settings made by the user. And, it is also possible to print out with the space of the rectangular image filled.

Accordingly, by applying the present invention, an effect can be expected that the running cost required for printout can be suppressed to a low level.

As described above, an aspect of the present invention provides a print control device which controls to print according to print data having one or plural image regions where an image is printed, including: a setting unit that sets whether or not printing of the image of the image region is omitted; and a print data generating unit that generates print data having a layout for omitting the printing of the image of the image region, when it is set by the setting unit that the printing of the image of the image region is omitted.

A second aspect of the present invention provides the print control device according to the first aspect of the invention, wherein the print data generating unit generates print data having a layout for filling a space for the image region by deleting the image region.

A third aspect of the present invention provides the print control device according to the first aspect of the invention, wherein the print data generating unit generates print data which keeps a layout by converting the image region into frame information enclosing the image region.

A fourth aspect of the present invention provides a method of controlling a print control device which controls to print according to print data having one or plural image regions where an image is printed, including: setting by a setting unit whether or not printing of the image of the image region is omitted; and generating by a print data generating unit the print data having a layout for omitting the printing of the image of the image region, when it is set by the setting unit that the printing of the image of the image region is omitted.

A fifth aspect of the present invention provides a storage medium readable by a computer, the storage medium storing a program of instructions executable by the computer to perform a function for controlling a printing according to print data having one or plural image regions where an image is printed, the function including: setting whether or not printing of the image of the image region is omitted; and generating print data having a layout for omitting the printing of the image of the image region when it is set that the printing of the image of the image region is omitted.

According to the above-mentioned aspects of the present invention, it is configured to make a print request of the print data newly generated with the rectangular image, which is included in the print data requested to be printed, decreased, so that the usage of the toner can be decreased, and the number of print sheets can be decreased, providing an effect that the printout can be performed at a low cost.

The invention is configured such that the image to be deleted can be designated by the user, so that it also provides an effect that an image can be formed without lacking information necessary for the user.

The present invention is not limited to the embodiments described above and shown in the drawings and various modifications may be made without deviating from the spirit and scope of the invention.

The present invention can be applied to an image forming device, method and program that an image can be formed at a low cost and is particularly useful for printout of a page including a photograph, a picture or a graph at a low cost.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling other skilled in the art to understand the invention for various embodiments and with the various modifications as are suited to the particular use contemplated. It is intended that the scope of the invention be defined by the following claims and their equivalents.

The entire disclosure of Japanese Patent Application No. 2005-84173 filed on Mar. 23, 2005 including specification, claims, drawings and abstract is incorporated herein by reference in its entirety.

What is claimed is:

1. A print control device which controls to print according to print data having one or plural image regions where an image is printed, comprising:
a setting unit that sets whether or not printing of the image of the image region is omitted; and
a print data generating unit that generates print data having a layout for omitting the printing of the image of the image region, when it is set by the setting unit that the printing of the image of the image region is omitted.

2. The print control device according to claim 1, wherein the print data generating unit generates print data having a layout for filling a space for the image region by deleting the image region.

3. The print control device according to claim 1, wherein the print data generating unit generates print data which keeps a layout by converting the image region into frame information enclosing the image region.

4. A method of controlling a print control device which controls to print according to print data having one or plural image regions where an image is printed, comprising:
setting by a setting unit whether or not printing of the image of the image region is omitted; and
generating by a print data generating unit the print data having a layout for omitting the printing of the image of the image region, when it is set by the setting unit that the printing of the image of the image region is omitted.

5. A storage medium readable by a computer, the storage medium storing a program of instructions executable by the computer to perform a function for controlling a printing according to print data having one or plural image regions where an image is printed, the function comprising:
setting whether or not printing of the image of the image region is omitted; and
generating print data having a layout for omitting the printing of the image of the image region when it is set that the printing of the image of the image region is omitted.
